(19) United States
(12) Patent Application Publication
(10) Pub. No.: US 2014/0250374 A1
(43) Pub. Date: Sep. 4, 2014

(54) INFORMATION PROCESSING APPARATUS, METHOD, AND PROGRAM

(71) Applicant: Sony Corporation, Tokyo (JP)

(72) Inventors: Yoshihito Ohki, Tokyo (JP); Tatsushi Nashida, Kanagawa (JP); Shoichiro Moriya, Tokyo (JP)

(73) Assignee: Sony Corporation, Tokyo (JP)

(21) Appl. No.: 14/347,076

(22) PCT Filed: Sep. 26, 2012
(86) PCT No.: PCT/JP2012/006116

§ 371 Date: Mar. 25, 2014

(30) Foreign Application Priority Data
Oct. 3, 2011 (JP) 2011-219156

(51) Int. Cl. G06F 17/21

(52) U.S. Cl. CPC G06F 17/212
USPC 715/247

(57) ABSTRACT

An information processing apparatus may include a processing unit to control layout of article information on a display, where the layout is to include a plurality of display areas, the display areas include first and second text display areas and a number of characters to be displayed in the first and second text display areas is determined, respectively, by a size of the first and second text display areas

### CROSS-REFERENCE TO RELATED APPLICATIONS

This application claims priority from Japanese Patent Application No. JP 2011-219156 filed in the Japan Patent Office on Oct. 3, 2011, the entire contents of which is hereby incorporated by reference.

### TECHNICAL FIELD

The present technology relates to an information processing apparatus, an information processing method, and a program thereof, and particularly to an information processing apparatus, an information processing method, and a program thereof capable of appropriately changing a content display state in accordance with a display type and allowing a viewer to get a quick overview of the entire content after the change to grasp the outline.

### BACKGROUND ART

In recent years, many devices have been developed which display content mainly including characters, such as newspapers and books, and allow for browsing the content.

Such devices may pose a following problem when content in a layout in consideration of a device with a prescribed size is displayed on another device, for example.

That is, the content which has simply been reduced in size may cause deterioration in the readability when another device on which the content is to be displayed has a smaller screen than that of the prescribed device or when aspect ratios thereof are different from each other, for example.

Examples of countermeasures against such a problem include a method in which content is displayed in the form of a list, for example. A configuration is applicable in which character strings included in a desired article are displayed on a display when browsing of the article is instructed from a list of articles of content such as a newspaper, for example.

Moreover, a technique has also been proposed in which a character string is specified for each of a plurality of articles to be displayed on a screen for a paper image and sizes of display areas, which are for displaying articles, on the screen for a paper image are adjusted in accordance with a number of characters in each article character string to be displayed (see JP-A-2008-262306, for example).

### SUMMARY

### Technical Problem

In content such as a newspaper, however, article layout positions on a paper and styles of titles and headlines have important meanings.

For example, an article which is considered to apparently attract readers is arranged in the right upper part on the paper, and related articles are arranged therearound in many cases. In addition, a larger display area on the paper is allocated to an article which is considered to be more important while a smaller display area on the paper is allocated to an article which is considered to be less important. Furthermore, articles with a high degree of importance are expressed by showing titles with outlined characters on black backgrounds or changing fonts of headlines, which makes it easier to sort out articles to be read.

That is, content such as a newspaper is configured to make it possible to get a quick overview of the entire content and to grasp the outline, by considering article layout positions on the paper, article display areas, and styles of titles and headlines.

If content is displayed as a list of articles as in the related art, for example, the aforementioned advantage in that it is possible to get a quick overview of the entire content and to grasp the outline is not achieved.

It is therefore desirable to make it possible to appropriately change a content display state in accordance with a display type and to get a quick overview of the entire content after the change to grasp the outline.

### Solution to Problem

In accordance with one embodiment, an information processing apparatus may include a processing unit to control layout of article information on a display, where the layout is to include a plurality of display areas, the display areas include first and second text display areas and a number of characters to be displayed in the first and second text display areas is determined, respectively, by a size of the first and second text display areas.

In accordance with another embodiment, a method for information processing may include controlling, by a processor, layout of article information on a display, where the layout is to include a plurality of display areas, the display areas include first and second text display areas and a number of characters to be displayed in the first and second text display areas is determined, respectively, by a size of the first and second text display areas.

In accordance with another embodiment, a non-transitory recording medium may be recorded with a program executable by a computer, and the program may include controlling layout of article information on a display, where the layout is to include a plurality of display areas, the display areas include first and second text display areas and a number of characters to be displayed in the first and second text display areas is determined, respectively, by a size of the first and second text display areas.

### Advantageous Effects

The embodiments of the present technology make it possible to appropriately change a content display state in accordance with a display type and to get a quick overview of the entire content after the change to grasp the outline.

### BRIEF DESCRIPTION OF DRAWINGS

FIG. 1 is a block diagram showing a configuration example of a content display system according to an embodiment of the present technology;

FIG. 2 is a diagram showing an example of an appearance of a display device to which the present technology is applied;

FIG. 3 is a diagram illustrating layout data;

FIG. 4 is a diagram showing an example in which a paper image of newspaper content is reduced in size and displayed;

FIG. 5 is a diagram showing an example in which a paper image of newspaper content is displayed by applying the present technology;

FIGS. 6A and 6B are diagrams illustrating examples of display in accordance with display sizes;

FIGS. 7A and 7B are diagrams illustrating example cases of intensified display;

FIG. 8 is a diagram showing an example of display areas for vertically written articles;

FIG. 9 is a diagram showing an example of grids allotted in accordance with occupancy of the display areas shown in FIG. 8;

FIG. 10 is a diagram illustrating a variation example in an article layout when vertical writing display is changed into horizontal writing display;

FIG. 11 is a diagram illustrating the variation example in the article layout when vertical writing display is changed into horizontal writing display;

FIG. 12 is a diagram illustrating the variation example in the article layout when vertical writing display is changed into horizontal writing display;

FIG. 13 is a diagram showing an example of a paper image displayed in a horizontal writing style;

FIG. 14 is a diagram showing an example case in which titles and headlines are displayed without body texts;

FIGS. 15A and 15B are diagrams illustrating an example case in which full texts of articles are displayed.

FIG. 16 is a diagram showing an example case in which a body text of an article in a predetermined area is displayed in a scrolled manner;

FIG. 17 is a diagram showing an example case in which a body text of an article in a predetermined area is displayed in an enlarged manner;

FIG. 18 is a diagram illustrating an example of paper image display processing;

FIG. 19 is a diagram illustrating an example of article display operation processing;

FIG. 20 is a diagram showing an example in which a display device according to an embodiment of the present technology is mounted to a part of a personal computer;

FIG. 21 is a diagram showing an example in which a display device according to an embodiment of the present technology is mounted to a part of a tablet terminal;

FIG. 22 is a diagram illustrating an example case in which the present technology is applied to English content; and

FIG. 23 is a block diagram showing a configuration example of a personal computer.

### DESCRIPTION OF EMBODIMENTS

Hereinafter, description will be given of embodiments of the present technology disclosed herein with reference to the drawings.

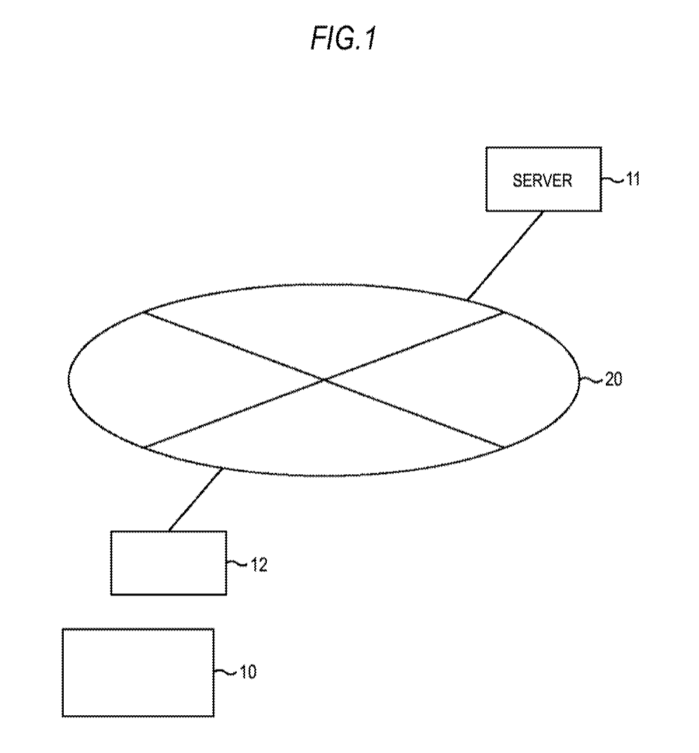

FIG. 1 is a block diagram showing a configuration example of a content display system according to an embodiment of the present technology. The content display system shown in the drawing includes a display device 10, a server 11, an access point 12, and a network 20.

The display device 10 is configured as an electronic device with a display for displaying content and a microcomputer provided therein, for example. In addition, the display device 10 is configured as a device with a communication function based on a predetermined communication protocol and designed to communicate with another device as necessary. The display device 10 is designed to process data, which has been obtained in communication with another device, by causing the microcomputer to execute a program and display a predetermined image on the display.

The display device 10 accesses the network 20 via the access point 12 to receive layout data, text data, and the like transmitted from the server 11. In addition, the display device 10 is designed to display on the display the content based on the layout data, the text data, and the like, which have been received from the server 11, by executing an installed application program or the like.

The server 11 is a server operated and managed by a business operator who provides content, for example. The server 11 is a server of a newspaper publishing company for distributing newspapers as content, for example, and transmits the layout data and the text data to the display device 10 via the network 20.

Although the above description was given of a case of the display device 10 accessing the network 20 via the access point 12 to which the display device 10 was connected via wireless communication, the display device 10 may be connected directly to the network 20.

In addition, there may be more display devices in practice while a single display device 10 is described herein. In the case of newspaper content, for example, a plurality of users can view the newspaper by a plurality of display devices accessing the server 11 via the network 20.

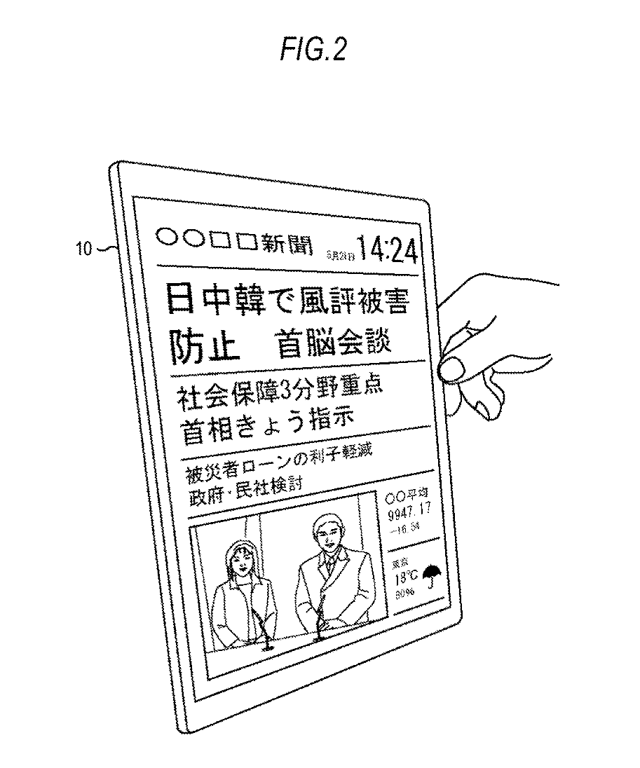

FIG. 2 is a diagram showing an example of the appearance of the display device 10 in FIG. 1, to which the present technology is applied. As shown in the drawing, the display device 10 is configured as an extremely thin box-shaped (hexahedron) device with a display provided at least on one surface. The display is configured by an electronic paper, for example. In addition, the display may be a liquid crystal display.

In addition, the display of the display device 10 is configured to include therein a proximity panel which detects a variation in electrostatic capacitance to detect the proximity of a user finger or the like. When a user brings a finger to the proximity to the display of the display device 10, a variation in electrostatic capacitance is detected at a predetermined position on the panel, and a signal indicating a degree of proximity of the user's finger or the like is output at the position. Accordingly, the display of the display device 10 can be used as a touch panel, and the image displayed on the display is an image as a GUI (Graphical User Interface) which can be operated.

In the example of FIG. 2, newspaper content is displayed on the display of the display device 10. The content displayed on the display of the display device 10 is displayed based on layout data and text data as will be described later.

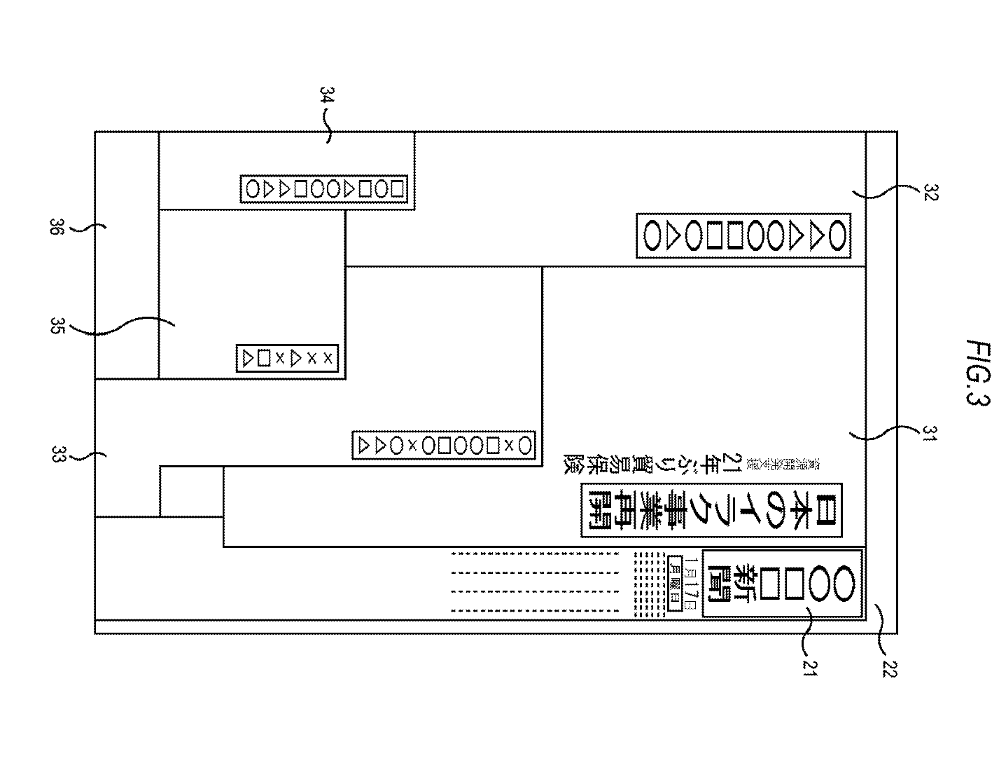

FIG. 3 is a diagram illustrating layout data. The drawing shows an example of layout for newspaper content.

In addition, figures and symbols such as “OO”, “ ”, “XX”, “ . . . ” are appropriately used in the drawings accompanying with this specification to express the characters displayed in spaces of a newspaper, for convenience sake.

In the example of FIG. 3, an area 21 is for displaying a name of newspaper (oo Newspaper), date, index, and the like in a vertical writing style. An area 22 is for displaying a name of newspaper, date, a page number, and the like in a horizontal writing style.

Moreover, areas 31 to 36 shown in the drawing are areas into which articles of the newspaper are inserted. That is, only a title and a headline of each article are displayed without a body text in each of the areas 31 to 36.

In FIG. 3, advertisements are appropriately inserted into the right lower part, the left lower part, and the like on the paper as necessary.

The layout data is information for designating a position, a size, and a shape of an area for displaying each article, a title and a headline of each article, and styles for the titles and the headline of each article as shown in FIG. 3, for example. It is not necessary that the layout data is data for displaying a screen as shown in FIG. 3.

For example, the layout data includes information for specifying on the paper a position, a size, a shape, and the like of the area for displaying each article (coordinates, for example) and position information for specifying parts, in which titles and headlines are displayed, in each area. Furthermore, the layout data includes texts constituting a title and a headline of each article, information on a font, a character size, white characters on a black background/black characters on a white background/outlined characters, and the like of a title of each article, and information on a character size and the like of a headline.

Moreover, the layout data may include picture images relating to articles. In addition, the layout data may include text or images arranged as a diary, blog or message using services of a social networking service.

The layout data is created and transmitted by a newspaper publishing company which provides newspaper content, for example. In addition, the newspaper publishing company which provides newspaper content creates text data for article body texts to be displayed in the areas 31 to 36 in FIG. 3 and transmits the text data with the server 11 in FIG. 1 via the network 20, for example.

The text data for an article to be displayed in a certain area is associated with the area designated by the layout data among a plurality of areas (the areas 31 to 36, for example). For example, an identification number for identifying each of the areas 31 to 36 is given in the layout data stored on the server 11, and the text data for each article is associated with the identification number and stored.

The layout data and the text data transmitted from the server 11 are received by the display device 10. Then, character strings corresponding to the text data are inserted into each of the areas 31 to 36 as designated by the layout data and then displayed on the display.

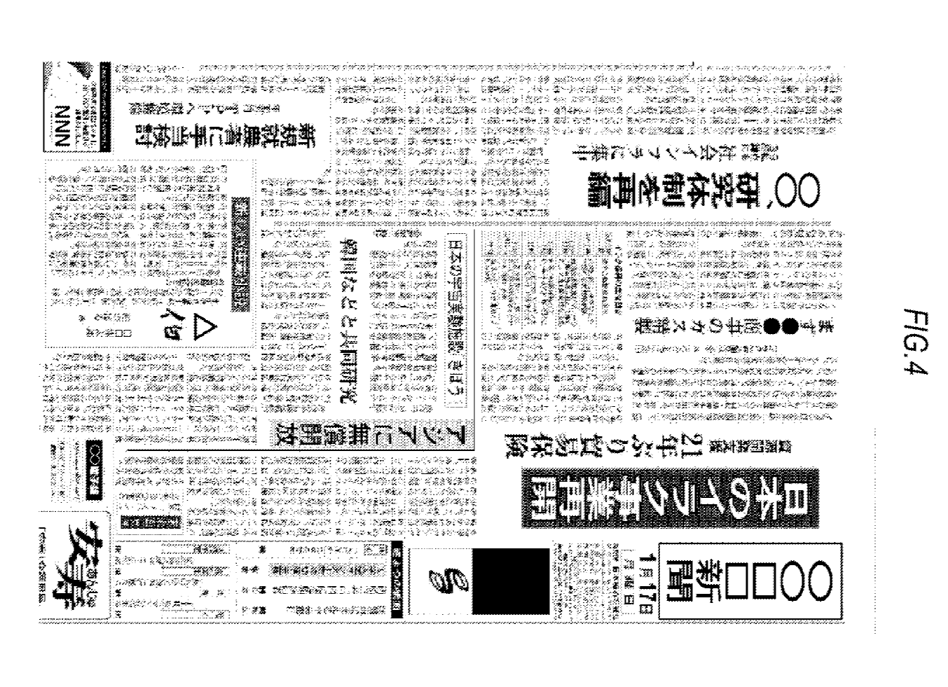

FIG. 4 is a diagram showing an example in which a paper image of newspaper content in the layout shown in FIG. 3 is reduced in size and displayed on the display of the display device 10. Since the display of the display device 10 is too small to display the spaces of a newspaper as they are, the characters constituting the body texts of articles appear to be extremely small on the display.

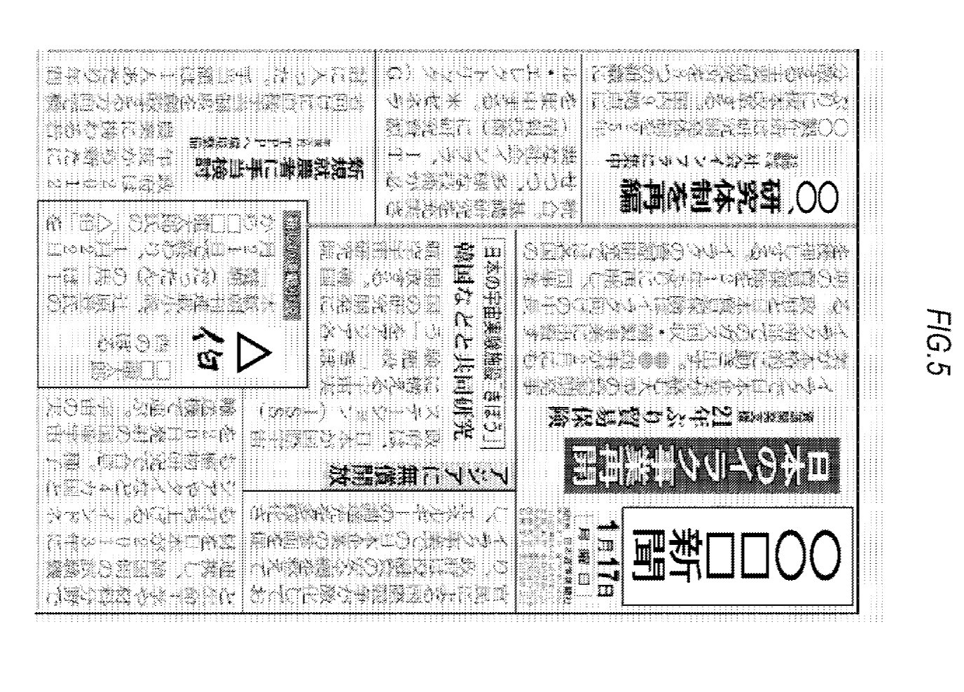

FIG. 5 is a diagram showing an example in which a paper image of newspaper content in the layout in FIG. 3 is displayed on the display of the display device 10 by applying the present technology. In the example of this drawing, the paper image is displayed at parts from which most parts of the area 21 and the entire area 22 shown in FIG. 3 and the advertisements have been deleted.

In the example of FIG. 5, the display device 10 receives the layout data and sets the position, the size, and the shape of each area for displaying each article, the title and the headline of each article, and the styles of the title and the headline of each article as shown in FIG. 3. In so doing, it is possible to display the image as shown in FIG. 3.

In addition, the layout data is transmitted from the server 11 of the newspaper publishing company, which is connected to the network 20, for example, and the display device 10 is designed to receive the layout data via the network 20.

Moreover, in the example of FIG. 5, the display device 10 deletes most parts of the area 21 and the entire area 22 shown in FIG. 3 and the advertisements and rearranges the areas 31 to 36. On this occasion, the deleted parts are allocated to areas for displaying nearby articles and added to predetermined areas among the areas 31 to 36.

Furthermore, in the example of FIG. 5, the display device 10 receives the text data and displays character strings of the article body texts in the areas 31 to 36. On this occasion, the character sizes, the intervals between the characters, and the like are automatically set based on the size, the resolution, and the like of the display of the display device 10, for example. Standard character sizes and intervals between the characters, which do not cause deterioration in the user readability, are provided in advance, for example. The intervals between the characters are set to be slightly longer when the display size is larger than a predetermined size, and the character sizes are set to be slightly larger when the resolution of the display is lower than a predetermined resolution, for example.

In so doing, the paper image is displayed as shown in FIG. 5. In the example of FIG. 5, an article on each area is partially displayed. This is because the character sizes, the intervals between the characters, and the like which do not cause deterioration in the user readability have been set as described above and there is not enough space to display all characters of each article in each of the areas 31 to 36 designated by the layout data.

However, it is considered that the user can get a quick overview of the entire paper image displayed on the display and grasp the outline even if all characters of each article are not displayed since articles of a newspaper are generally arranged such that more details are described in the later parts.

The user can display a full text of an article on a corresponding area by performing a clicking operation on the area among areas for displaying articles shown in FIG. 5, for example. That is, a full text of the article is displayed on the screen of the display based on the text data of the full text of the article to be displayed in the clicked area.

In addition, the character sizes of the title and the headline of each article and the number of characters in the body text of the article to be displayed on the display are changed in accordance with the display size of the display device 10. For example, when the display size of the display device 10 is small, the character sizes of the title and the headline of each article are set to be small so as to be displayed at positions designated by the layout data. Moreover, when the display size of the display device 10 is small, the number of characters in the body text of the article to be displayed on the display is reduced, for example.

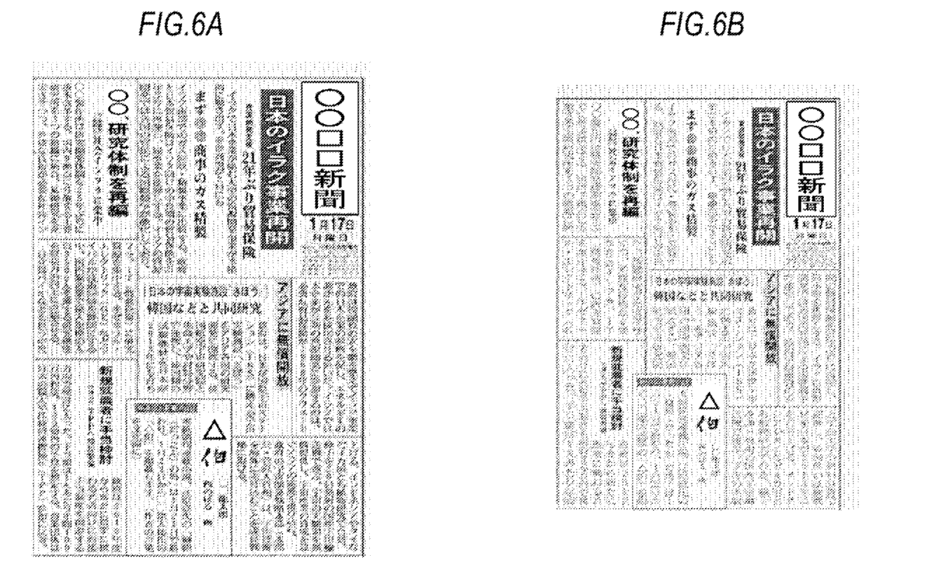

FIGS. 6A and 6B are diagrams illustrating examples of paper image display in accordance with display sizes of the display device 10. Both FIGS. 6A and 6B show examples of the image when the same paper image of newspaper content is displayed based on the same layout data. Here, FIG. 6B shows an example of the image when the paper image is displayed on a smaller display than that in FIG. 6A.

In FIG. 6B, character sizes of the title and the headline of each article are set to be smaller than those in the case of FIG. 6A. In addition, the numbers of characters in the body texts of the articles displayed on the display in FIG. 6B are smaller than those in the case of FIG. 6A.

For example, the article arranged at the left lower part on the display ends with “ . . . annual allowance per a person” in FIG. 6B while the article continues as “ . . . annual allowance per a person is OOO thousands yen . . . ” on the paper in FIG. 4. That is, the number of the characters in the article is adjusted to be smaller in accordance with the display size.

In addition, it is a matter of fact that a configuration is also applicable in which a character size for headlines and a number of characters in a body text of an article to be displayed on the display are set to be uniform regardless of the display size of the display device 10.

Alternatively, the character sizes of a title and a headline of each article and a number of characters in a body text of an article may be changed in accordance with the display size of the display device 10 in response to an instruction from the user.

Moreover, a predetermined article may be displayed in an intensified manner among the articles displayed on the display of the display device 10, for example. An article to be displayed in the intensified manner may be specified based on an amount of traffic or a number of citations on social network services, for example, and the display state of the area for the article may be changed. In such a case, information relating to the amount of traffic, the number of citations on social network services, or the like of each article may be obtained from the server 11 via the network 20, for example.

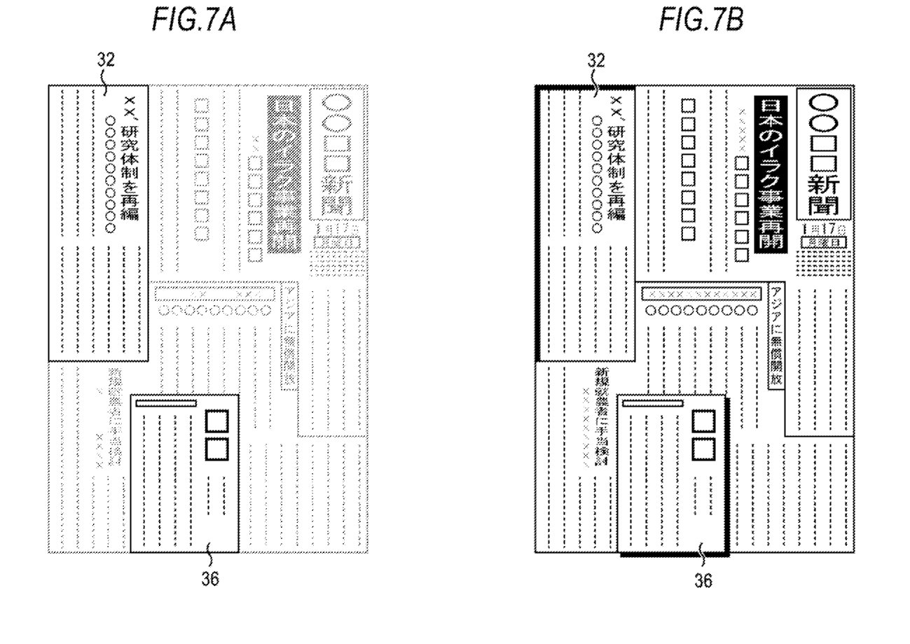

FIGS. 7A and 7B are diagrams illustrating example cases of intensified display of predetermined articles among the articles displayed on the display of the display device 10.

FIG. 7A is a diagram showing an example case in which articles to be intensified are displayed with a thick color while the other articles are paled out. In this example, the articles displayed in the area 32 and the area 36 are displayed with a thick color while the other articles are paled out.

In addition, when the display of the display device 10 enables 3D display, for example, the articles to be displayed in an intensified manner may be displayed so as to be raised from the screen. FIG. 7B is a diagram showing an example case in which the articles to be displayed in an intensified manner are displayed so as to be raised from the screen. In this example, the articles displayed in the area 32 and the area 36 are displayed so as to be raised from the screen.

The aforementioned intensified display may be automatically performed by the display device 10 or may be performed in response to an instruction from the user.

In addition, articles are displayed in a vertical or horizontal writing style in accordance with an aspect ratio of the display of the display device 10.

For example, the articles are displayed in the vertical writing style when the length of the display in a lateral direction (horizontal direction) is shorter than the length thereof in a longitudinal direction (vertical direction), and the articles are displayed in the horizontal writing style when the length of the display in the lateral direction (horizontal direction) is longer than the length thereof in the longitudinal direction (vertical direction).

According to the embodiment of the present technology, the display device 10 is designed to automatically determine a display area for each article for a case of horizontal writing display when the layout data has been created on the assumption of the vertical writing display, for example.

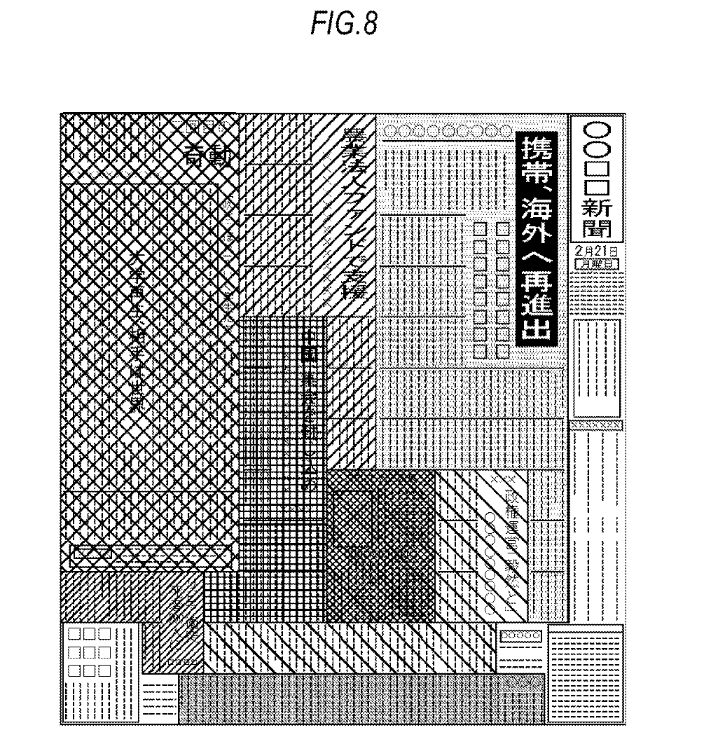

In determining a display area for an article to be displayed in a horizontal writing style based on the layout data on the assumption of the vertical writing display, occupancy of each article on the paper is firstly obtained based on the layout data. It is assumed that the layout data has determined the display area for each article in the vertical writing style as shown in FIG. 8, for example. In such a case, the display device 10 calculates the occupancy of the area, in which each article is displayed, on the paper. In calculating the occupancy, the area for displaying the name of the newspaper, date, a page number, and the like, the area for displaying advertisements, and the like are deleted, and the occupancy on the paper is then calculated.

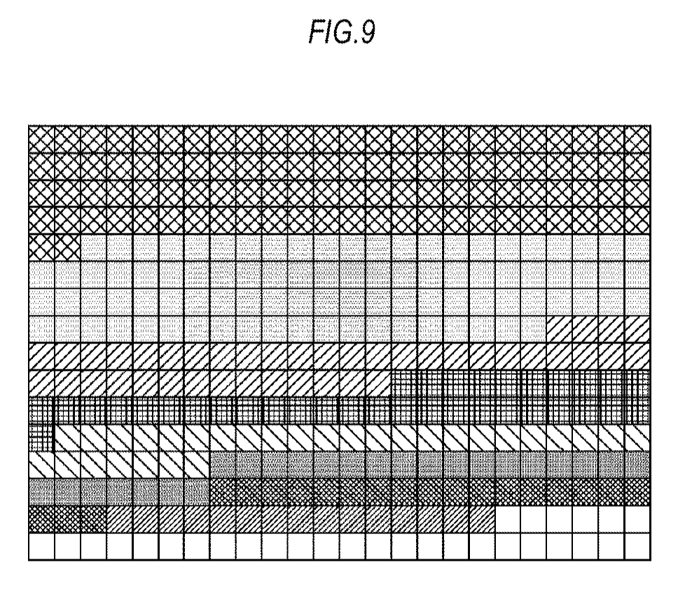

Then, the display device 10 divides the whole display into a plurality of lattice-shaped grids and allots grids by a number corresponding to the display area for each article in accordance with the thus calculated occupancy. FIG. 9 shows an example in which the display area for each article shown in FIG. 8 is allotted as grids by a number corresponding to the occupancy.

Next, the display device 10 specifies the arrangement of the display area for each article. On this occasion, articles which have been arranged at four corners on the paper in the layout data are extracted, for example.

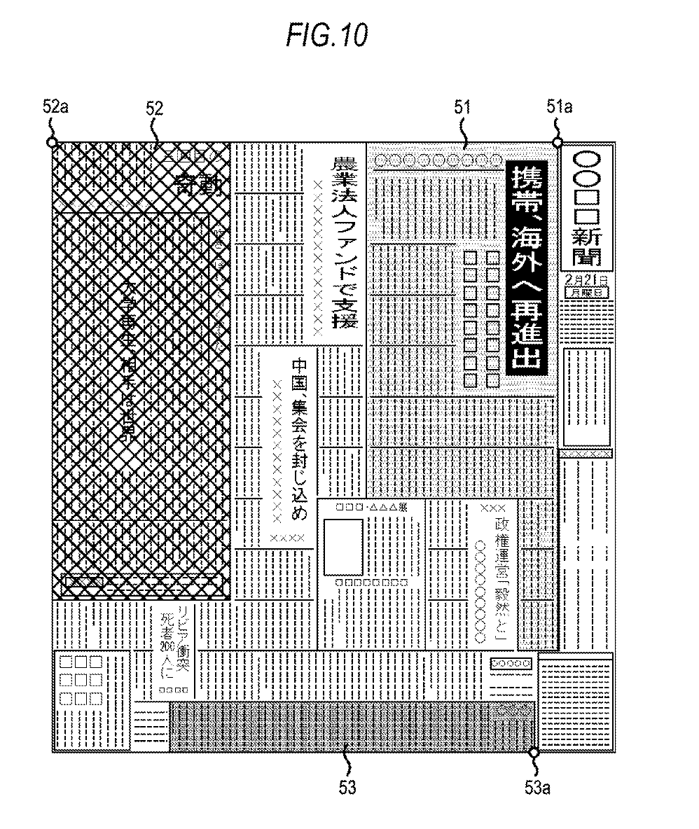

In a case of a paper displayed as shown in FIG. 10, attention will be paid to an article displayed in an area 51, an article displayed in an area 52, and an article displayed in an area 53.

The area 51 includes a point 51a at the right upper corner on the paper. Although the name of this newspaper, date, and the like are displayed at the right upper corner on the paper in practice, the name of this newspaper, the date, and the like are not articles, and therefore, the point 51a of the area 51 is recognized as a right upper corner on the paper.

The area 52 includes a point 52a at the left upper corner on the paper. Although date, a page number, and the like are displayed at the left upper corner on the paper in practice, the date, the page number, and the like are not articles, and therefore, the point 52a of the area 52 is recognized as a left upper corner on the paper.

The area 53 includes a point 53a at the right lower corner on the paper. Although advertisements and the like are displayed at the right lower corner on the paper in practice, the advertisements and the like are not articles, and therefore, the point 53a of the area 53 is recognized as a right lower corner on the paper.

As described above, the display device 10 specifies the article in the area 51 as the article at the right upper corner, the article in the area 52 as the article at the left upper corner, and the article in the area 53 as the article at the right lower corner in the vertical writing display state. Then, the display device 10 specifies arrangement positions of the articles in the horizontal writing display state.

Although an article at the left lower corner is not extracted in this example, the article at the left lower corner may be extracted in the same manner.

In the case of vertical writing display, an article which will attract the greatest attention is typically arranged at the right upper corner. This is because readers typically start to read the characters at the right upper corner on the paper in the case of vertical writing, in many cases. In addition, the articles arranged at the left upper corner, the right lower corner, and the left lower corner are arranged with some meaning in terms of the layout on the paper in many cases. Thus, the arrangement of the articles in the vertical writing display state is converted into the arrangement in the horizontal writing display state while the positional relationships among the articles arranged at the four corners on the paper are maintained in the embodiment of the present technology.

In the case of horizontal writing display, an article which attracts the greatest attention is typically arranged at the left upper corner. This is because readers typically start to read the characters at the left upper corner on the paper in the case of horizontal writing, in many cases. Thus, it is desirable that the article arranged at the right upper corner on the paper in the vertical writing display state be arranged at the left upper corner on the paper in the horizontal display state.

According to the embodiment of the present technology, the arrangement positions of the articles in the vertical writing display are rotated in the counterclockwise direction by 90° and associated with the arrangement positions of the articles in the horizontal writing display, for example. In so doing, the article arranged at the right upper corner in the vertical writing display is associated with the left upper corner in the vertical writing display, the article arranged at the left upper corner in the vertical writing display is associated with the left lower corner in the horizontal writing display, and the article arranged at the right lower corner in the vertical writing display is associated with the right upper corner in the horizontal writing display.

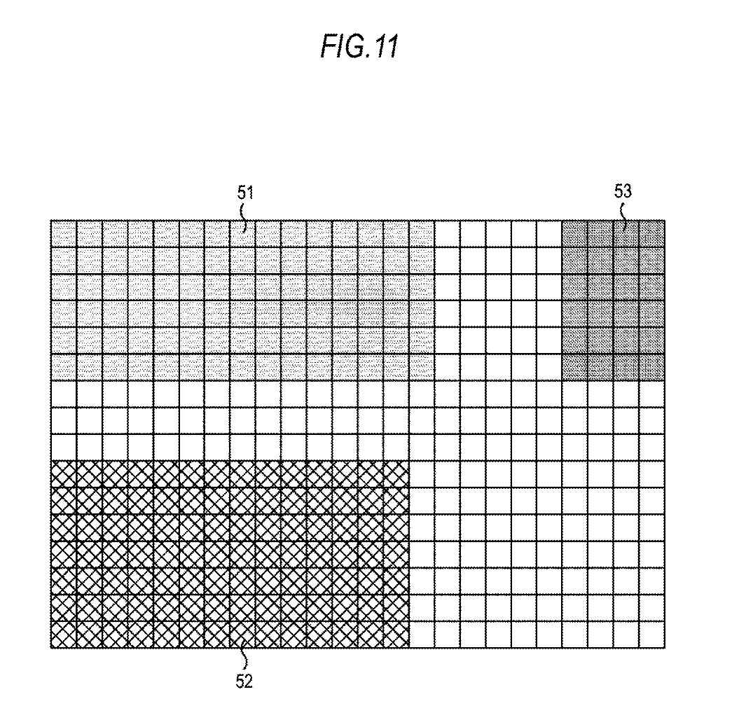

For example, the arrangement of the articles in the vertical writing display as shown in FIG. 10 is changed into the arrangement of the articles in the horizontal writing display as shown in FIG. 11. In the example of FIG. 11, the article in the area 51 is arranged at the left upper corner on the paper, the article in the area 52 is arranged at the left lower corner on the paper, and the article in the area 53 is arranged at the right upper corner on the paper.

Articles other than the articles at the four corners on the paper are arranged in an order from an article which is in contact with each side (outer frame) of the paper and has the highest occupancy (the largest number of allotted grids) by creating a rectangle with an area corresponding to the number of grids allotted in accordance with the occupancy.

Among the articles other than the articles at the four corners of the paper, an article in contact with the upper side among the four sides of the paper in the vertical writing display is arranged so as to be in contact with the left side among the four sides of the paper in the horizontal writing display, for example. Among the articles other than the articles at the four corners of the paper, an article in contact with the left side among the four sides of the paper in the vertical writing display is arranged so as to be in contact with the lower side among the four sides of the paper in the horizontal writing display, and arrangement of an article in contact with each side is similarly changed. On this occasion, if it is difficult to arrange all articles, which have been arranged in contact with predetermined sides in the vertical writing display, so as to be in contact with corresponding sides in the horizontal writing display, an article with the largest number of allotted grids is arranged so as to be in contact with each side with priority.

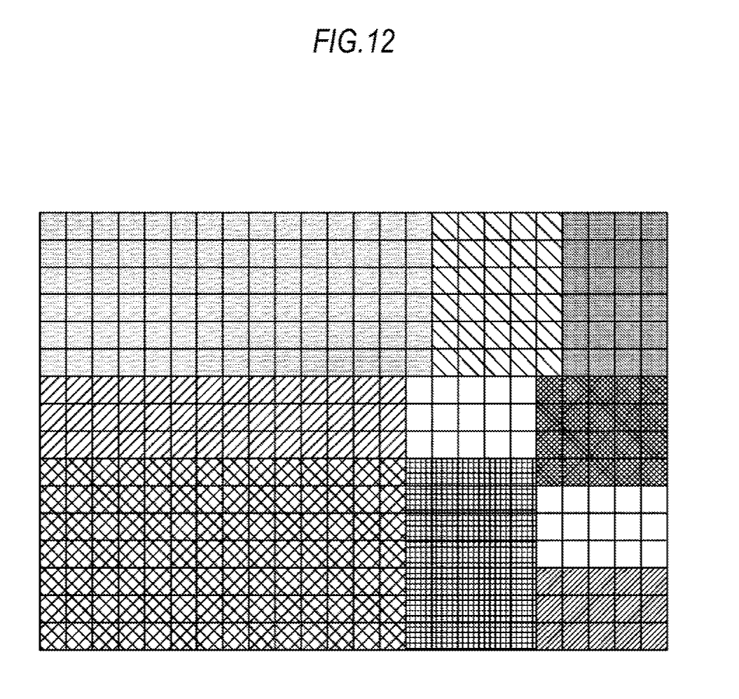

Accordingly, a display area for each article in the horizontal writing display is determined as shown in FIG. 12 for the paper of the vertical writing display as shown in FIG. 8, for example.

In addition, the aforementioned method for determining the display area for each article was described as an example, and the display area for each article may be determined based on a different method.

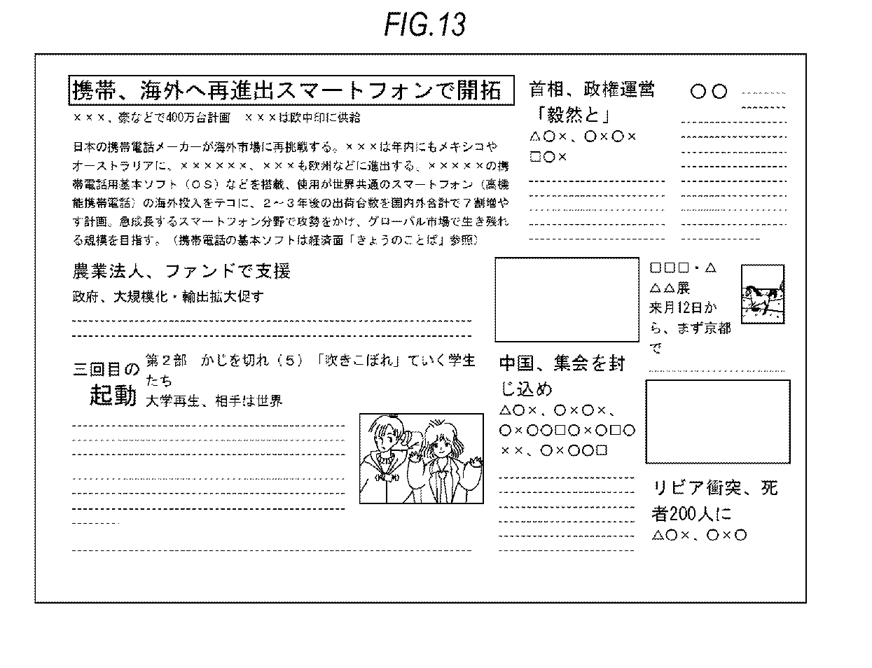

Then, a title, a headline, and character strings of body texts of an article are displayed on the display area for each article as shown in FIG. 13, for example. On this occasion, the character sizes, the intervals between the characters, and the like are automatically set so as not to cause deterioration in user readability, for example. In addition, the number of characters of an article displayed in each area is automatically determined in accordance with the character sizes and the intervals between the characters.

In addition, if the display area for each article is designed to be clicked, the full text of the article is displayed as will be described later.

Although the above description was given of an example case in which the layout data was created on the assumption of the vertical writing display, the horizontal writing display maybe similarly changed into the vertical writing display when the layout data has been created on the assumption of the horizontal writing display.

In addition, although the above description was given of an example in which the display device 10 automatically changed between the vertical writing display and the horizontal writing display, the change between the vertical writing display and the horizontal writing display may be made in response to an instruction from the user, for example.

Moreover, titles and headlines may be displayed without body texts of the articles as necessary. For example, the titles and the headlines may be displayed without the body texts of the articles when the battery-powered display device 10 is mounted on a battery charger (a docking station).

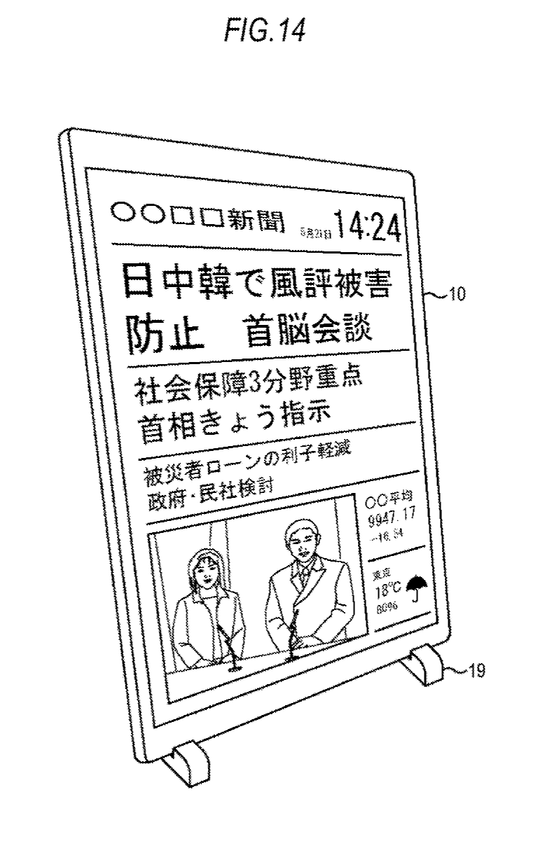

FIG. 14 is a diagram showing an example case in which titles and headlines are displayed without body texts in the display device 10. In the example of the drawing, the display device 10 is mounted on a docking station 19, and titles of articles and a picture are displayed in an enlarged manner. The display device 10 is designed such that the display state of the display is changed when a microcomputer or the like of the display device 10 detects that the display device 10 has been mounted on the docking station, for example.

In addition, the character sizes of the titles are set in accordance with the arrangement of the articles designated by the layout data, for example.

In this example, the character size of a title of an article displayed at the uppermost part in the drawing is the largest, the character size of a title of an article displayed at the lowermost part in the drawing is the smallest, and the character size of a title of an article displayed at the center in the drawing is the middle. For example, the article of the title displayed at the uppermost part is an article designated to be arranged at the right upper corner on the paper by the layout data, the article of the title displayed at the center is an article designated to be arranged at the left upper corner on the paper by the layout data, and the article of the title displayed at the lowermost part is an article designated to be arranged at the right lower corner on the paper by the layout data, in FIG. 14.

It is possible to check outlines of articles in a newspaper even if the display of the display device 10 is viewed from a distant location, by displaying the titles of the articles and the picture in an enlarged manner. When the docking station 19 is installed at a corner of a room, for example, and the display device 10 is mounted on the docking station 19, the user can check the outlines of the articles in the newspaper from a distant location.

In addition, a full text of an article is displayed when an operation such as clicking is performed on the title of the article in the state as shown in FIG. 14.

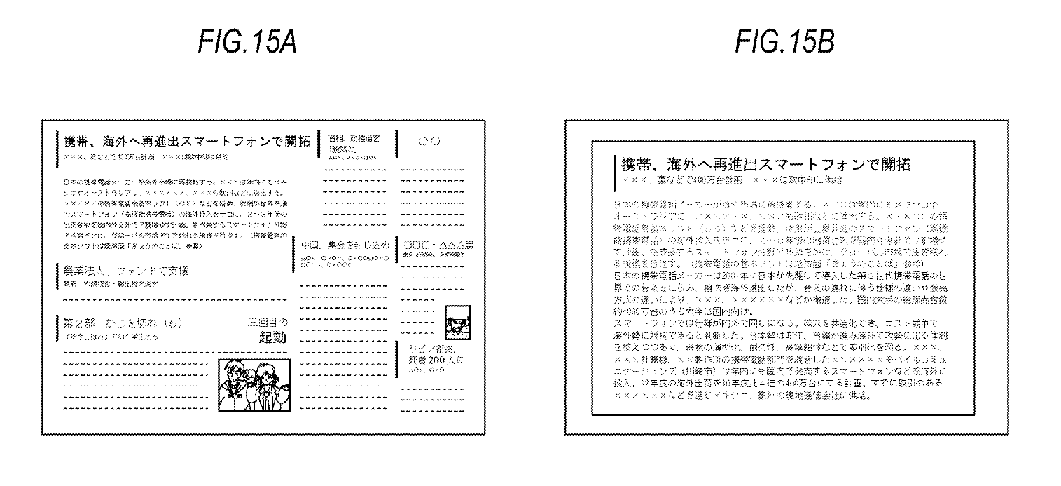

FIGS. 15A and 15B are diagrams illustrating an example case in which full texts of articles are displayed. FIG. 15A is a diagram showing an example case in which one page of a paper is displayed on the display of the display device 10. FIG. 15B is a diagram showing an example case in which a full text of an article arranged at the left upper corner in FIG. 15A is displayed. The display device 10 can display the full text of the article at the left upper part in FIG. 15A as shown in FIG. 15B by performing an operation such as clicking with a finger of the user on a part of an area in which the article is displayed.

In FIG. 15B, the full text of the article is displayed while a part thereof is paled out. That is, the characters in the part displayed in FIG. 15A among the body texts of the article displayed at the left upper corner on the paper in FIG. 15A are paled out in FIG. 15B. In so doing, the user who has already read a part of the article in FIG. 15A can easily recognize a continuing part of the article, for example.

It is a matter of course that the full texts of the article maybe displayed with the same color (in the same display state) in FIG. 15B.

Alternatively, the characters in the part displayed in FIG. 15A may not be displayed on the screen in FIG. 15B. That is, the body text of the article which has been displayed in the screen for displaying the entire page of the paper may not be displayed on the screen for displaying the full text of the article.

Moreover, when the number of characters in the body text is large, and it is difficult to display the full text even on the screen in FIG. 15B, for example, a part of the article may be displayed on the screen in FIG. 15B. In such a case, the screen shown in FIG. 15B may be displayed in a scrolled manner, for example. The user may scroll the display of the full text of the article by swiping or flicking the screen in FIG. 15B with a finger of the user, for example.

Alternatively, a desired article may be scrolled and displayed on the screen for displaying the entire page of the paper, for example. By swiping or flicking with a finger of the user the area for the article at the left upper part in FIG. 15A, the display of the body text of the article may be scrolled.

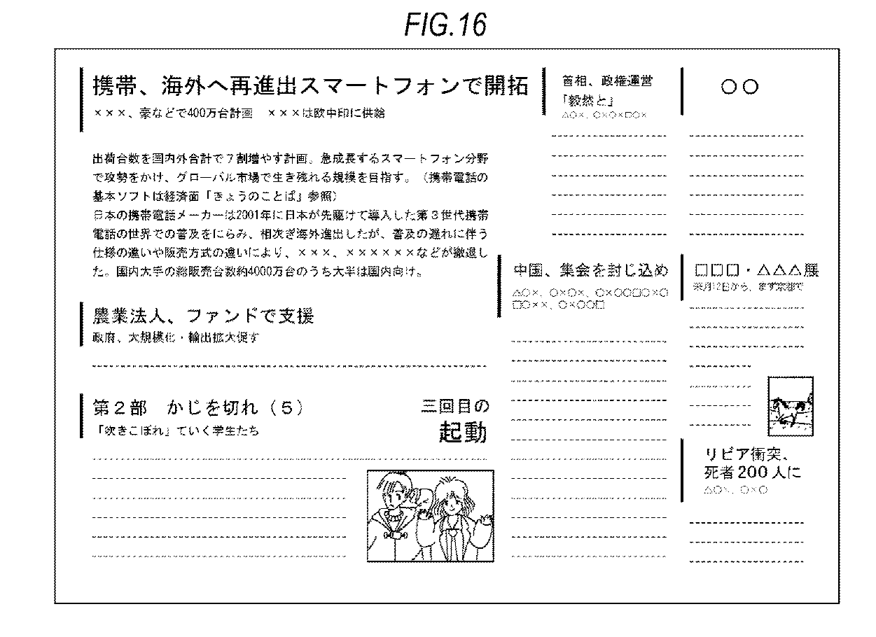

FIG. 16 is a diagram showing an example case in which the body text of the article at the left upper corner on the paper in FIG. 15A is scrolled and displayed. In this example, the character strings hidden on the lower side of the area at the left upper corner in FIG. 15A are displayed with the character strings appearing in the area at the left upper corner in FIG. 16 by scrolling the body text of the article. In so doing, the user can view a body text of an article of interest while grasping a structure on the paper.

Furthermore, characters in a desired article may be displayed in an enlarged manner on the screen for displaying the entire page of the paper, for example. The characters of the body text of the article may be displayed in an enlarged manner by pinching out the area, in which the article at the left upper part in FIG. 15A is displayed, with a finger of the user, for example.

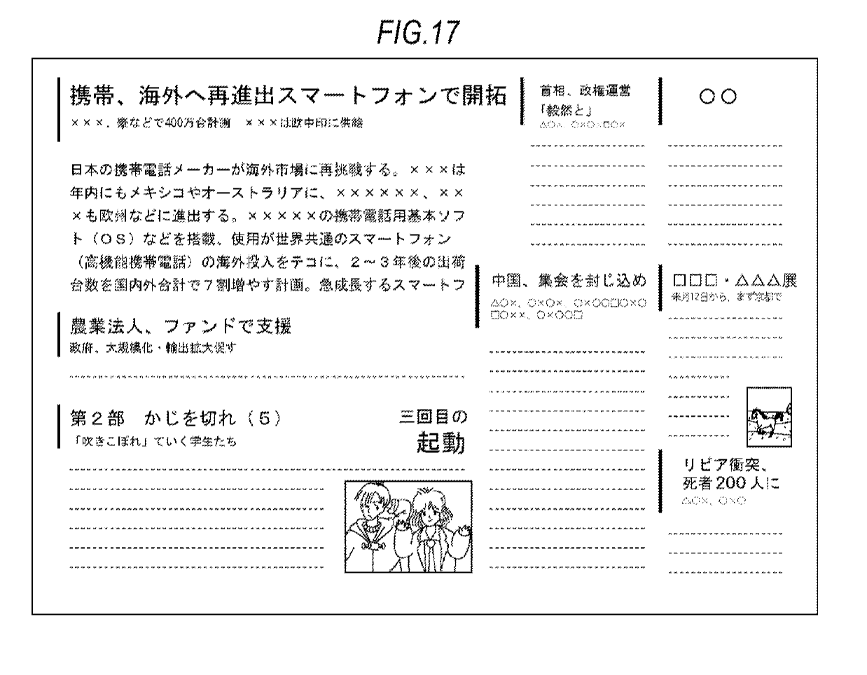

FIG. 17 is a diagram showing an example case in which the body text of the article at the left upper corner on the paper in FIG. 15A is displayed in an enlarged manner. In so doing, the user can enlarge and read the characters in a part which is difficult to read, for example, while grasping a structure on the paper.

Although the above description was given of an example in which characters were enlarged with a pinching-out operation, the characters may be downsized with a pinching-in operation. In so doing, the user allows the display device to display the downsized characters of a body text of an article in a predetermined area and to display more characters of the body text of the article.

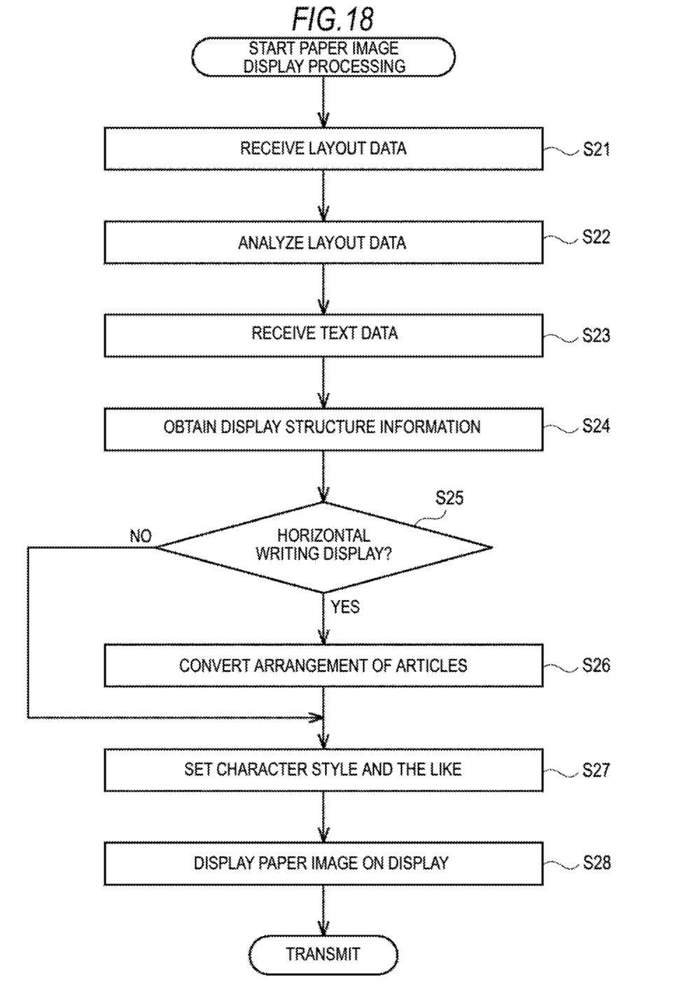

Next, description will be given of an example of paper image display processing by the display device 10 with reference to a flowchart in FIG. 18.

In Step S21, the display device 10 receives layout data, which has been transmitted from the server 11, via the network.

In Step S22, the display device 10 analyzes the layout data received in Step S21. In so doing, individual areas for displaying articles are recognized.

In Step S23, the display device 10 receives text data for the articles to be displayed in the areas recognized as a result of the processing in Step S22, from the server 11 via the network 20. In Step S23, text data for full texts of the articles may be received, or text data for some parts of the articles may be received.

If the display device 10 is designed to receive some parts of the articles, the text data for full texts of the articles is received in response to an operation of a user for displaying the full texts of the article, for example.

Alternatively, if the display device 10 is designed to receive the text data for full texts of the articles, text data for all articles may be received on this occasion, or some parts of the articles may be selectively received. For an article which is considered to have a high probability of the user reading the article based on browsing habits and preference information of the user, text data for a full text of the article is received, and text data for the other articles is received only for some parts of the articles.

In Step S24, display structure information for the display device 10 is obtained. Here, the display structure information is information including a display size, an aspect ratio, and resolution.

In Step S25, the display device 10 determines whether to display the articles in the horizontal writing style based on the display structure information obtained in Step S24. For example, when the length of the display in the lateral direction (horizontal direction) is longer than the length thereof in the longitudinal direction (vertical direction), it is determined to be necessary to display the articles in the horizontal writing style in Step S25.

When it is determined to be necessary to display the articles in the horizontal writing style in Step S25, the processing proceeds to Step S26.

In Step S26, the display device 10 converts arrangement of the articles. On this occasion, arrangement of the articles for the vertical writing display is converted into arrangement of the articles for the horizontal writing display as described above with reference to FIGS. 8 to 12, for example.

On the other hand, when it is determined that the articles are not suitable for the horizontal writing display in Step S25, the processing in Step S26 is skipped.

In Step S27, the display device 10 sets conditions including a character style. On this occasion, the size, the resolution, and the like of the display are specified based on the display structure information obtained in the processing in Step S24, and character sizes, intervals between the characters, and the like of the body texts of the articles are set, for example. In addition, character sizes of titles and headlines of the articles as designated by the layout data are changed as necessary.

In Step S27, if there is an article to be displayed in an intensified manner, characters of the article are set to be displayed with a thick color as described above with reference to FIG. 7A, or the characters to be displayed in an intensified manner are set to be displayed so as to be raised from the screen as described above with reference to FIG. 7B.

In Step S28, the display device 10 displays the paper image on the display. In so doing, the paper image is displayed as described above with reference to FIGS. 6A, 6B, 7A, 7B, and 13, for example.

The paper image display processing is executed as described above.

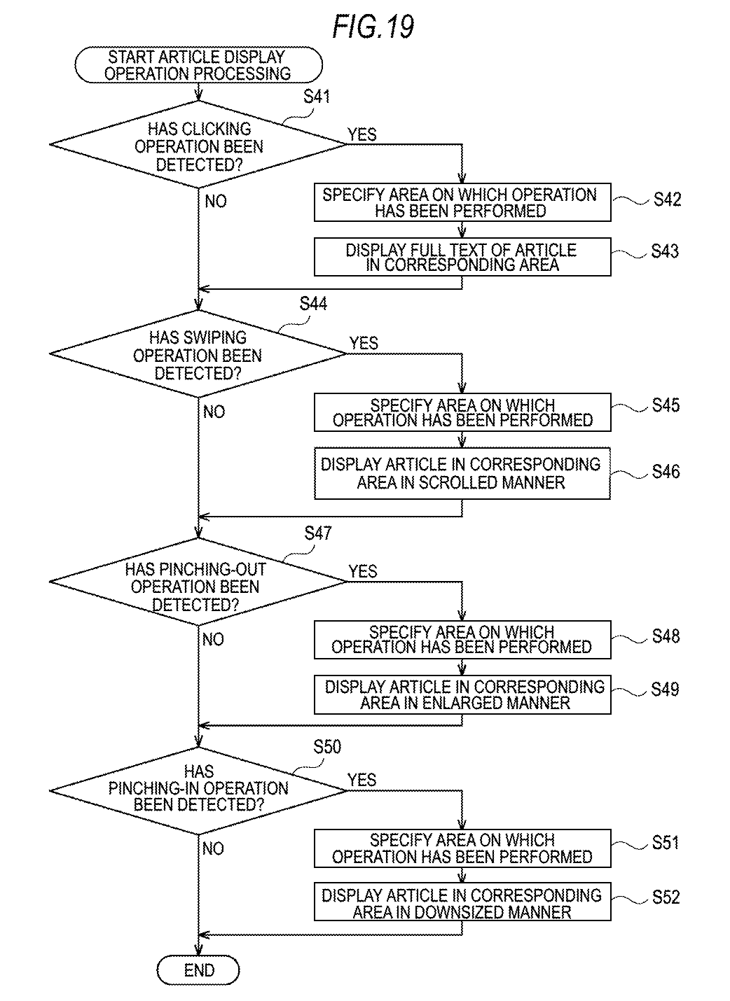

Next, description will be given of an example of article display operation processing by the display device 10 with reference to a flowchart in FIG. 19. This processing is executed while the paper image is displayed as described above with reference to FIGS. 6A, 6B, 7A, 7B, and 13, for example, in the paper image display processing described above with reference to FIG. 18, for example.

In Step S41, the display device 10 determines whether a clicking operation has been detected. For example, when the user clicks a part of an area, in which an article is displayed, on the display with a finger, it is determined that the clicking operation has been detected in Step S41.

When it is determined that the clicking operation has been detected in Step S41, the processing proceeds to Step S42.

In Step S42, the display device 10 specifies the area on which the operation has been performed. In so doing, an area in which the clicking operation has been detected is specified among a plurality of areas (areas for displaying the articles) designated by the layout data, for example.

In Step S43, the display device 10 display a full text of an article to be displayed in the area specified in the processing in Step S42. For example, when the user clicks a part of an area, in which the article at the left upper part in FIG. 15A is displayed, with the finger, the full text of the article is displayed as shown in FIG. 15B.

On this occasion, characters in the part which has been displayed on the screen for displaying the paper image may be paled out as described above with reference to FIGS. 15A and 15B, for example.

Alternatively, the body text of the article which has been displayed on the screen for displaying the paper image may not be displayed on the screen for displaying the full text of the article.

Furthermore, apart of the article may be displayed even on the screen for displaying the full text of the article when it is difficult to display the full text due to a large number of characters in the full text of the article, for example.

When it is determined that the clicking operation has not been detected in Step S41, or after the processing in Step S43, the processing proceeds to Step S44.

In Step S44, the display device 10 determines whether or not a swiping (or flicking) operation has been detected. For example, when the user swipes a part of an area, in which an article is displayed, with the finger, it is determined that the swiping operation has been detected in Step S44.

When it is determined that the swiping operation has been detected in Step S44, the processing proceeds to Step S45.

In Step S45, the display device 10 specifies the area on which the operation has been performed. In so doing, an area in which the swiping operation has been detected is specified among a plurality of areas (areas for displaying the articles) designated by the layout data, for example.

In Step S46, the display device 10 displays in a scrolled manner the article to be displayed in the area specified in the processing in Step S45.

When it is determined that the swiping operation has not been detected in Step S44, or after the processing in Step S46, the processing proceeds to Step S47.

In Step S47, the display device 10 determines whether or not a pinching-out operation has been detected. For example, when the user performs an operation of widening (pinching out) a part of an area, in which an article is displayed, on the display with the finger, it is determined that the pinching-out operation has been detected in Step S47.

When it is determined that the pinching-out operation has been detected in Step S47, the processing proceeds to Step S48.

In Step S48, the display device 10 specifies the area on which the operation has been performed. In so doing, an area in which the pinching-out operation has been detected is specified among a plurality of areas (areas for displaying the articles) designated by the layout data, for example.

In Step S49, the display device 10 enlarges and displays the characters of the article to be displayed in the area specified in the processing in Step S48.

When it is determined that the pinching-out operation has not been detected in Step S47, or after the processing in Step S49, the processing proceeds to Step S50.

In Step S50, the display device 10 determines whether or not a pinching-in operation has been detected. For example, when the user performs an operation of holding (pinching in) a part of an area, in which an article is displayed, on the display with the finger, it is determined that the pinching-in operation has been detected in Step S50.

When it is determined that the pinching-in operation has been detected in Step S50, the processing proceeds to Step S51.

In Step S51, the display device 10 specifies the area on which the operation has been performed. In so doing, an area in which the pinching-in operation has been detected is specified among a plurality of areas (areas for displaying the articles) designated by the layout data, for example.

In Step S52, the display device 10 downsizes and displays the characters of the article to be displayed in the area specified in the processing in Step S51.

When it is determined that the pinching-in operation has not been detected in Step S50, or after the processing in Step S52, the processing is completed.

The article display operation processing is executed as described above.

In addition, it is not necessary that the display device 10 to which the present technology is applied is configured as a single device as shown in FIG. 2, and the display device 10 may be configured as a combination of two or more devices, for example.

For example, when the display of the display device 10 is configured with the use of an electronic paper, the display device 10 may be configured so as to be attached to a part of a predetermined electronic device. For example, the display device 10 may be mounted on a part of a notebook personal computer or a part of a tablet terminal.

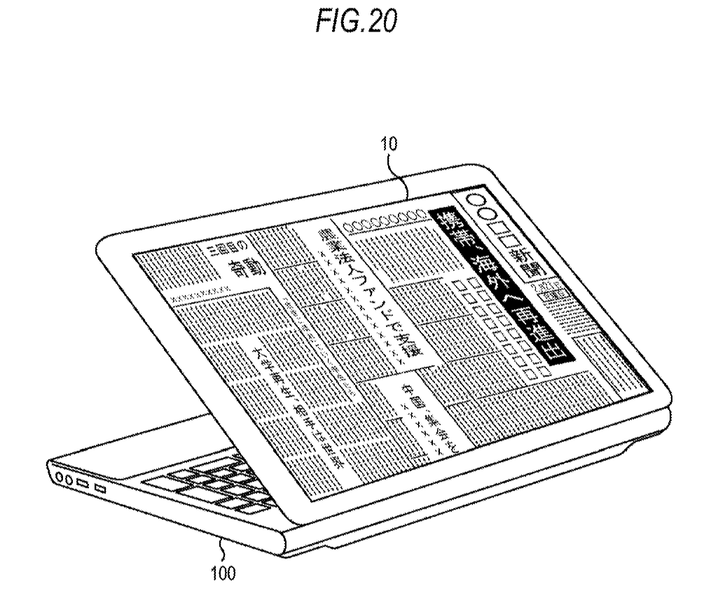

FIG. 20 is a diagram showing an example case in which the display device 10 is mounted to apart of a notebook personal computer. In this example, the display device 10 is mounted on the rear side of the display of the notebook personal computer.

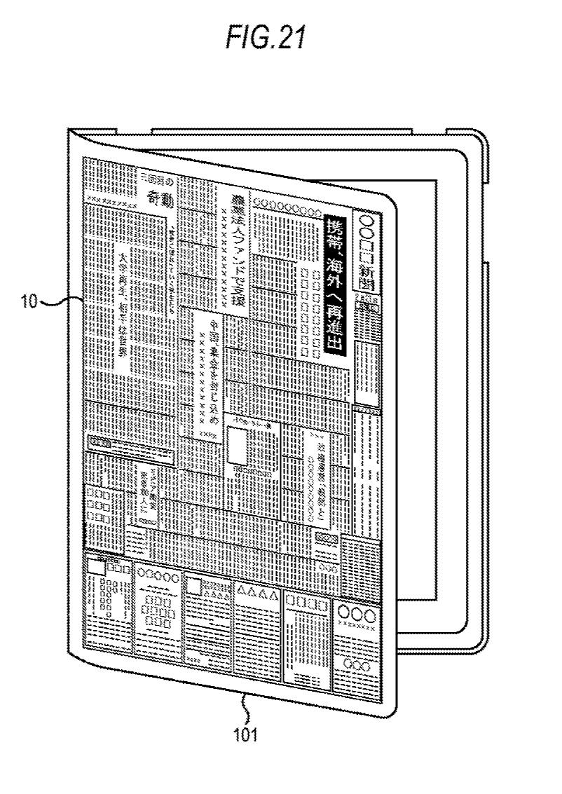

FIG. 21 is a diagram showing an example case in which the display device 10 is mounted on apart of a tablet terminal. In this example, the display device 10 is mounted on the rear side of the display of the tablet terminal.

In so doing, a battery for the personal computer or the tablet terminal can be used for supplying power to the display device 10, and it is necessary to mount a battery on the display device 10, for example. Therefore, the display device 10 can be greatly reduced in thickness and weight.

In addition, since the electronic paper can hold a displayed image for a predetermined period without power supply, the user can view content such as a newspaper even in the state in which the personal computer or the tablet terminal is turned off.

Although the above description was given of an example in which the layout data was created by the server 11 and transmitted to the display device 10, the display device 10 may create the layout data, for example. In such a case, the display device 10 may receive titles and headlines of articles simply as text data, determine arrangement of the articles, positions of the titles and the headlines, styles and the like based on a method designated in advance, and create the layout data.

In addition, although the above description was given of an example case in which newspaper content was mainly displayed on the display device 10, it is also possible to apply the present technology to a case of displaying magazine content or web page content on the display device 10, for example.

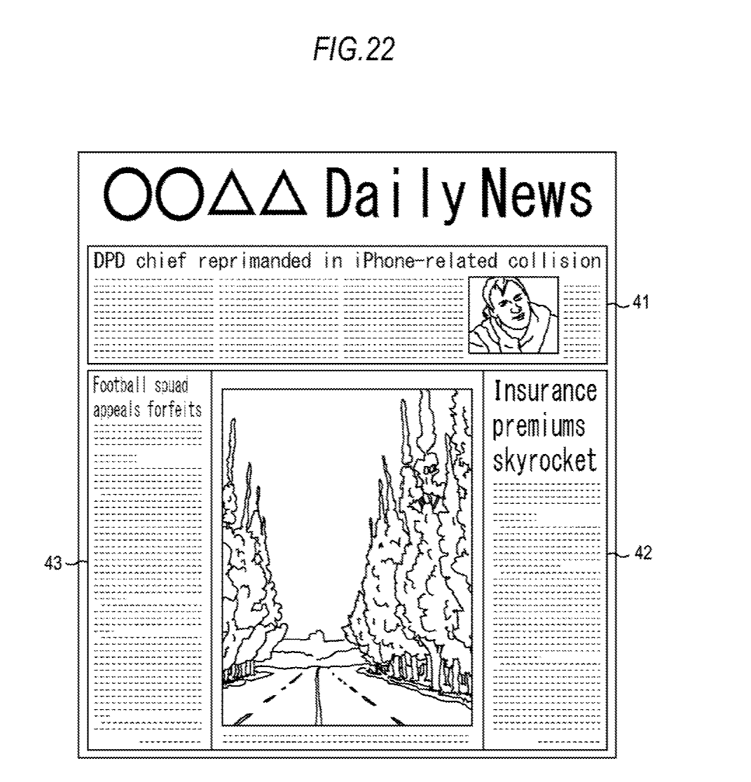

Moreover, although the above description was given of a case in which Japanese content was displayed, the present technology can be applied to languages other than Japanese. FIG. 22 is a diagram illustrating an example case in which the present technology is applied to English content.

As shown in FIG. 22, newspaper content of English articles is displayed on the display device 10 in this example. The English newspaper content shown in the drawing is originally written in the horizontal writing style, and therefore, layout data for the horizontal writing display state is provided.

In this example, articles are respectively arranged in an area 41, an area 42, and an area 43. When the display size of the display device 10 is small, the number of characters of body texts of articles displayed on the display becomes small as described above. For example, the article in the area 41 continues as “ . . . measures to curb inflation and demand for exports falters in Europe and the U.S. . . . ” on the original paper while the article ends with “ . . . measures to curb inflation and” in the state shown in FIG. 22 (the state displayed on the display of the display device 10) on the display.

It is a matter of fact that the display state of each area is changed as necessary even in the example of FIG. 22. For example, a predetermined article can be displayed in an intensified manner as described above with reference to FIGS. 7A and 7B among articles displayed on the display of the display device 10 even in the example of FIG. 22. In addition, a full text of an article can be displayed as described above with reference to FIGS. 15A and 15B by the user clicking a part of the area 41 with the finger, for example. Alternatively, the display of the full text of the article may be scrolled as described above with reference to FIG. 16 by the user swiping or flicking the area 41 with the finger, for example. Furthermore, the characters of the body text of the article may be displayed in an enlarged manner by the user pinching out the area 41 with the finger, for example.

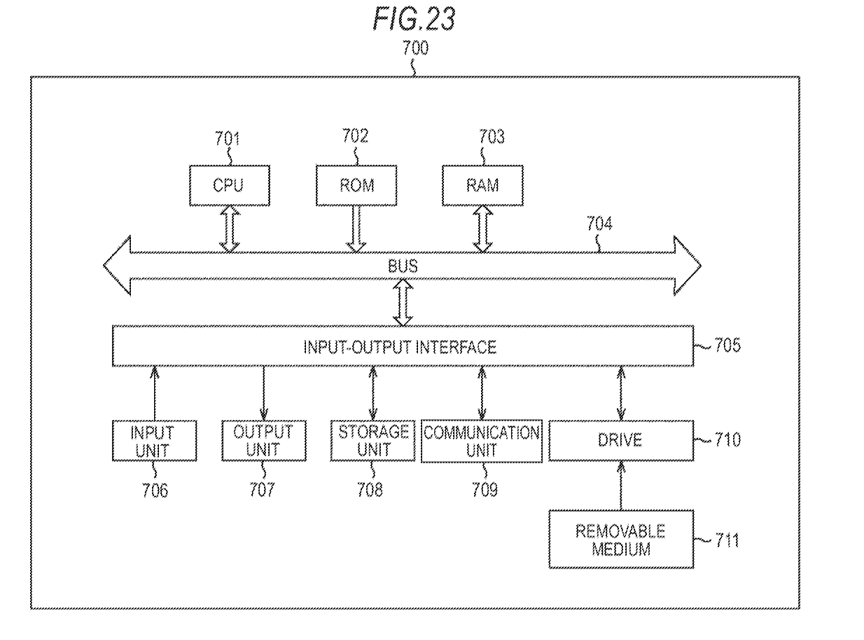

The aforementioned series of processing can be executed by hardware or software. When the aforementioned series of processing is executed by software, the program configuring the software is installed from a network or a recording medium on a computer mounted on a dedicated hardware or a general-use personal computer 700 as shown in FIG. 23, which is capable of executing various functions by various programs installed thereon.

In FIG. 23, a CPU (Central Processing Unit) 701 executes various kinds of processing based on programs stored on a ROM (Read Only Memory) 702 or programs loaded from a storage unit 708 on a RAM (Random Access Memory) 703. Also, the RAM 703 appropriately stores data necessary for the CPU 701 to execute various kinds of processing.

The CPU 701, the ROM 702, and the RAM 703 are connected to each other via a bus 704. An input-output interface 705 is also connected to the bus 704.

An input unit 706 including a keyboard and a mouse, an output unit 707 including a display such as an LCD (Liquid Crystal Display) and a speaker, a storage unit 708 including a hard disk, and a communication unit 709 including a modem and a network interface card such as a LAN card are connected to the input-output interface 705. The communication unit 709 performs communication processing via the network including the Internet.

A drive 710 is also connected to the input-output interface 705 as necessary, a removable medium 711 such as a magnetic disk, an optical disc, or a semiconductor memory is appropriately mounted thereon, and a computer program read from the removable medium 711 is installed on the storage unit 708 as necessary.

When the aforementioned series of processing is executed by software, the program configuring the software is installed from a network such as the Internet or a recording medium such as a removable medium 711.

The recording medium is configured separately from the device main body as shown in FIG. 23 by the ROM 702 recording the program or by the hard disk included in the storage unit 708, which is pre-installed on the device main body and distributed to the user, as well as by the removable medium 711 such as a magnetic disk (including a floppy disk (registered trademark)), an optical disc (including a CR-ROM (Compact Disc-Read Only Memory) and a DVD (Digital Versatile Disc)), or a magneto-optical disk (MD (Mini-Disc) (registered trademark)), which records the program thereon, or a semiconductor memory.

In addition, the series of processing described herein includes the time-series processing executed in the order described above, of course, and also includes processing executed in parallel or individually, which is not necessarily performed in the time-series manner.

Moreover, embodiments of the present technology are not limited to those described above, and various modifications can be made within the scope of the preset technology.

The present technology may also implemented as the following configurations.

(1) An information processing apparatus comprising:

a processing unit to control layout of article information on a display,

wherein the layout is to include a plurality of display areas,

wherein the display areas include first and second text display areas, and

wherein a number of characters to be displayed in the first and second text display areas is determined, respectively, by a size of the first and second text display areas.

(2) The apparatus according to (1), wherein the layout of the article information is a page having at least a title display area and the first and second text display areas.
(3) The apparatus according to (1), wherein the processing unit controls the layout using layout data including information associated with a size of a display of a display device and from which the first and second text display areas are determined.
(4) The apparatus according to (1), wherein, in response to a zooming operation by a user, the processing unit controls display of the characters to be enlarged in one of the text display areas without changing of a size of the one of the text display areas.
(5) The apparatus according to (1), wherein, in response to a pinching operation by a user, the processing unit controls display of the characters to be enlarged or downsized in one of the text display areas without changing of a size of the one of the text display areas.
(6) The apparatus according to (1), wherein, in response to a scroll operation by a user, the processing unit controls display of next continuous text in one of the text display areas without changing of a size of the one of the text display areas.
(7) The apparatus according to (1), wherein, in response to a scroll operation by a user, the processing unit controls display of next continuous text in one of the text display areas without changing of a display of other of the text display areas.
(8) The apparatus according to (1), wherein the first layout is different from the second layout.
(9) The apparatus according to (1), wherein the article information includes at least one of text or an image.
(10) The apparatus according to (1), wherein the display is a touch panel.
(11) The apparatus according to (10), wherein, in response to a pinching operation by a user at an area of the display at which one of the text display areas is displayed, the processing unit controls display of the characters to be enlarged or downsized in the one of the text display areas without changing of a size of the one of the text display areas.
(12) The apparatus according to (1), wherein a size of the characters displayed in the first and second text display areas is changeable in accordance with an instruction of a user.
(13) The apparatus according to (1), wherein the article information includes content arranged using a service of a social networking service.
(14) The apparatus according to (1), wherein the number of characters displayed in one of the text display areas is set to be uniform.
(15) The apparatus according to (1), wherein a size of the first and second text display areas is in accordance with the article information and a size of the display.
(16) The apparatus according to (1), wherein a size of the first and second text display areas is in accordance with the article information and a type of a display device including the display.
(17) The apparatus according to (1), wherein the processing unit controls a size of the characters displayed in the first and second text display areas in accordance with layout data and a quantity of text to be displayed in the first and second text display areas.
(18) The apparatus according to (1), wherein the processing unit controls the layout using layout data including metadata information including at least one of recommendation information based on user preference or access information to content by other users.
(19) The apparatus according to (1), wherein the first and second text display areas have respective first and second display settings.
(20). A method for information processing comprising:

controlling, by a processor, layout of article information on a display, wherein the layout is to include a plurality of display areas, wherein the display areas include first and second text display areas, and wherein a number of characters to be displayed in the first and second text display areas is determined, respectively, by a size of the first and second text display areas.

(21). A non-transitory recording medium recorded with a program executable by a computer, the program comprising: controlling layout of article information on a display, wherein the layout is to include a plurality of display areas, wherein the display areas include first and second text display areas, and wherein a number of characters to be displayed in the first and second text display areas is determined, respectively, by a size of the first and second text display areas.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

10: DISPLAY DEVICE
11: SERVER
12: ACCESS POINT
20: NETWORK
701: CPU

1. An information processing apparatus comprising:
a processing unit to control layout of article information on a display,
wherein the layout is to include a plurality of display areas,
wherein the display areas include first and second text display areas, and
wherein a number of characters to be displayed in the first and second text display areas is determined, respectively, by a size of the first and second text display areas.

2. The apparatus of claim 1, wherein the layout of the article information is a page having at least a title display area and the first and second text display areas.

3. The apparatus of claim 1, wherein the processing unit controls the layout using layout data including information associated with a size of a display of a display device and from which the first and second text display areas are determined.

4. The apparatus of claim 1, wherein, in response to a zooming operation by a user, the processing unit controls display of the characters to be enlarged in one of the text display areas without changing of a size of the one of the text display areas.

5. The apparatus of claim 1, wherein, in response to a pinching operation by a user, the processing unit controls display of the characters to be enlarged or downsized in one of the text display areas without changing of a size of the one of the text display areas.

6. The apparatus of claim 1, wherein, in response to a scroll operation by a user, the processing unit controls display of next continuous text in one of the text display areas without changing of a size of the one of the text display areas.

7. The apparatus of claim 1, wherein, in response to a scroll operation by a user, the processing unit controls display of next continuous text in one of the text display areas without changing of a display of other of the text display areas.

8. The apparatus of claim 1, wherein the first layout is different from the second layout.

9. The apparatus of claim 1, wherein the article information includes at least one of text or an image.

10. The apparatus of claim 1, wherein the display is a touch panel.

11. The apparatus of claim 10, wherein, in response to a pinching operation by a user at an area of the display at which one of the text display areas is displayed, the processing unit controls display of the characters to be enlarged or downsized in the one of the text display areas without changing of a size of the one of the text display areas.

12. The apparatus of claim 1, wherein a size of the characters displayed in the first and second text display areas is changeable in accordance with an instruction of a user.

13. The apparatus of claim 1, wherein the article information includes content arranged using a service of a social networking service.

14. The apparatus of claim 1, wherein the number of characters displayed in one of the text display areas is set to be uniform.

15. The apparatus of claim 1, wherein a size of the first and second text display areas is in accordance with the article information and a size of the display.

16. The apparatus of claim 1, wherein a size of the first and second text display areas is in accordance with the article information and a type of a display device including the display.

17. The apparatus of claim 1, wherein the processing unit controls a size of the characters displayed in the first and second text display areas in accordance with layout data and a quantity of text to be displayed in the first and second text display areas.

18. The apparatus of claim 1, wherein the processing unit controls the layout using layout data including metadata information including at least one of recommendation information based on user preference or access information to content by other users.

19. A method for information processing comprising:
controlling, by a processor, layout of article information on a display, wherein the layout is to include a plurality of display areas, wherein the display areas include first and second text display areas, and wherein a number of characters to be displayed in the first and second text display areas is determined, respectively, by a size of the first and second text display areas.

20. A non-transitory recording medium recorded with a program executable by a computer, the program comprising:
controlling layout of article information on a display, wherein the layout is to include a plurality of display areas, wherein the display areas include first and second text display areas, and wherein a number of characters to be displayed in the first and second text display areas is determined, respectively, by a size of the first and second text display areas.
